(19) United States
(12) Patent Application Publication
(10) Pub. No.: US 2026/0367051 A1
(43) Pub. Date: Nov. 19, 2026

(54) SAMPLE SUBSTRATE, LIQUID SAMPLE ANALYZING APPARATUS, AND METHOD FOR PREPARING LIQUID SAMPLES, IN PARTICULAR FOR A LC-MS ANALYSIS

(71) Applicant: Scienion GmbH, Berlin (DE)

(72) Inventors: Anjali SETH, Lyon (FR); Tom CALATAYUD, Lyon (FR)

(21) Appl. No.: 19/133,694

(22) PCT Filed: Dec. 1, 2023
(86) PCT No.: PCT/EP2023/083997

§ 371 Date: May 28, 2025

(30) Foreign Application Priority Data
Dec. 2, 2022 (EP) 22211050.4

(51) Int. Cl. G01N 30/72; B01L 3/00

(52) U.S. Cl. CPC G01N 30/7233; B01L 3/5085; B01L 2200/025; B01L 2200/026; B01L 2300/0819; B01L 2300/12

(57) ABSTRACT

A sample substrate (100), being adapted for preparing samples for an LC-MS analysis, comprises a reaction substrate device (10, 20) having a plurality of vessels (12, 22), each having at least one accommodating space being configured for accommodating a liquid sample and a vessel coupling section (15) with a vessel opening (13), and a plurality of collection cartridges (40), each having a cartridge coupling section (42) with a cartridge opening (43) and being configured for accommodating the liquid sample from one of the vessels (12, 22). Each vessel coupling section (15) is matched to each cartridge coupling section (42) with form-fitting so that they are adapted for coupling the reaction substrate device (10, 20) and the plurality of collection cartridges (40), thereby providing direct liquid communication of the vessels (12) and the collection cartridges (40) via the openings (13, 43) thereof. Furthermore, a liquid sample analyzing apparatus comprising the sample substrate (100) and a method of executing an LC-MS sample analysis, wherein the sample substrate (100) and an LC-MS apparatus are employed, are described.

### TECHNICAL FIELD

The present invention relates to a sample substrate, a liquid sample analyzing apparatus, and a method for preparing liquid samples, in particular for a LC-MS (liquid chromatography mass spectrometry) analysis. Applications of the invention are available, e.g., in the field of processing of liquid samples, in particular biological samples, e. g. in proteomics investigations.

### TECHNICAL BACKGROUND

In the present specification, reference is made to the following prior art relating to the technical background of the invention, in particular to preparing cell samples for mass spectrometry:
[1] US 2019/0209592A1 ;
[2] H. Specht et al. “Single-cell mass-spectrometry quantifies the emergence of macro-phage heterogeneity” doi: http://dx.doi.org/10.1101/665307;
[3] Y. Zhu et al. “Nanodroplet processing platform for deep and quantitative proteome pro-filing of 10-100 mammalian cells” in “NATURE COMMUNICATIONS” (2018) 9:882, DOI: 10.1038/s41467-018-03367-w;
[4] Z. Y. Li et al. “Nanoliter-Scale Oil-Air-Droplet Chip-Based Single Cell Proteomic Analysis” in “Anal. Chem.” 2018, 90, 5430-5438;
[5] US2019/0250130A1 ;
[6] EP 3 964 290 A1; and
[7] EP 4 075 145 A1.

It is generally known that there are increasing efforts in investigating the proteome, in particular analysing the entire set of proteins that is included in biological material, like biological cells or cell aggregates or cell components. Various antibodies based techniques and mass spectrometry based techniques for analysing the proteome are available, like e. g. mass cytometry (CyTOF), ma-trix-assisted laser desorption/ionization (MALDI), Single Cell ProtEomics by Mass Spectrometry (SCoPE-MS), antibody-based techniques or liquid chromatography mass spectrometry (LC-MS).

The latter has advantages in terms of the capability of detecting a large number of proteins per cell with high specificity.

LC-MS generally includes the following procedure. Biological cells are isolated, e. g. with a fluores-cence-activated cell sorter (FACS), and subjected to cell lysis for providing proteins included in the cells. The proteins are enzymatically digested into peptides fragments. In case of analysing single biological cells, these fragments typically are labelled with labelling molecules, like e. g. tandem mass tag (TMT) labels, serving as mass reporters, optionally followed by label quenching (removing unbound labelling molecules). After optional pooling of labelled samples, a separation of the peptide fragments by liquid chromatography (LC) is conducted. The peptide fragments are introduced into a tandem mass spectrometer and identified by peptide fingerprinting or tandem mass spectrometry, using bioinformatics techniques. The sample preparation steps from isolating the cells to pooling may be challenging in terms of parallel handling large numbers of samples included in small liquid quantities, keeping the assignment of the peptide fragments to certain samples and avoiding cross-contamination between different samples.

Current techniques for sample preparation are described e. g. in [1] to [4], which use the same general workflow for cell isolation, lysis, digestion, TMT labelling and sample collection, but differ with regard to the sample substrates and details of the applied reagents for lysis and digestion.

According to [1] and [2], lysis and digestion is applied in a micro-well plate with 384 wells, and the labelled samples are collected into a single glass HPLC insert. According to [3], home-made patterned glass slides are used for sample preparation. Using an oil layer for reducing evaporation from small liquid samples is proposed in [4], wherein a layer stack is used for creating sample receptacles and spanning self-supported oil film above each sample receptacle. A sample preparing apparatus for preparing liquid samples for a sample analysis is disclosed in [6], wherein a carrier plate device with an array of reaction sites is combined with a collection device having collection vessels. Each collection vessel is adapted for collecting the liquid samples from at least two of the reaction sites and for providing the liquid samples for the sample analysis. Adapting a collection device for positioning directly in a carousel of an autosampler apparatus, like a liquid chromatography autosampler apparatus, is described in [7].

Using the conventional substrates, like the 384-well plate, the patterned glass slides, the layer stack, the sample preparing apparatus of [6] or the collection device of [7], has the following disadvantages. Firstly, a 384-well plate is adapted for handling relatively large volumes in a range up to 100 μl. Furthermore, the substrates require complex lid handling for minimizing evaporation.

As a further disadvantage, transferring the labelled fragments from the wells to the glass HPLC insert or any other common collection vessel is time consuming, includes a risk of introducing contaminations and is prone to errors. For instance, according to [1], time-consuming pipetting one by one is used for the transferring task. Furthermore, in particular the patterned glass slides are specialized devices which are not adapted to all steps of the process chain, including further pre-ceding sample handling steps, like cell isolation. The layer stack used in [4] has a complex and costly structure. While [6] and [7] introduced some improvements in terms of sample pooling and transferring samples to a liquid chromatography autosampler apparatus, there are still limitations in the LC-MS analysis. Generally, the conventional techniques are not sufficiently adapted for an automation of sample preparation, resulting in limitations in terms of time consuming processes with human interaction and the risk of contaminations.

Thus, one significant particular disadvantage of the conventional techniques is that prepared samples have to be transferred manually to sample cartridges for executing an LC-MS sample analysis. For instance, commercially available Evotips® (see, e.g., [5]) have to be loaded manually with the samples. That means that the loading step of the sample prepared by any sample preparation method onto the Evotips® always include a time-consuming pipetting step. Additionally, the sample comes in contact with the walls of a pipette tip that may result in adsorptive losses of some of the peptides from the sample to be analyzed.

The above problems do not occur in preparing samples for mass spectrometry only, but also with other tasks of preparing liquid samples for a sample analysis by applying reagents to multiple samples and handling the samples.

### Objective of the Invention

The objectives of the invention are to provide an improved sample substrate, liquid sample analyzing apparatus, and method for preparing liquid samples, in particular for a LC-MS, being capable of avoiding disadvantages or limitations of conventional techniques. In particular, sample preparation is to be provided with a capability of facilitating multiplexing the sample preparation and analysis, decreasing operation time, handling reduced sample volumes down to the nanolitre (nl) range, minimizing or avoiding the evaporation problem, and/or facilitating the sample pooling. According to further aspects, the sample substrate is to be configured as user-friendly as possible and/or adapted for the whole process chain of a sample preparation, in particular LC-MS analysis, e. g., allowing an automation of the sample preparation.

### SUMMARY OF THE INVENTION

The above objectives are respectively solved by a sample substrate, a liquid sample analyzing apparatus, and sample preparing method, comprising the features of the independent claims. Features of preferred embodiments and applications of the invention are defined in the dependent claims.

According to a first general aspect of the invention, the above objective is solved by a sample substrate, being adapted for preparing samples for an LC-MS analysis (e.g., a proteomics mass spectrometry analysis). The sample substrate comprises a reaction substrate device having a plurality of vessels (e.g., wells or more complex receptacles or arrays of accommodating spaces). Each vessel (of the plurality of vessels) has at least one accommodating space (or: sub-vessel, sub-well) being configured for accommodating a liquid sample, preferably a sample droplet. Each vessel further has a vessel coupling section with a vessel opening.

The sample substrate further comprises a plurality of collection cartridges. Each collection cartridge (of the plurality of collection cartridges) has a cartridge coupling section with a cartridge opening. Each collection cartridge is configured for accommodating the liquid sample from one of the vessels. Each of the collection cartridges preferably has a shape of a pipette tip and/or conus and/or a column shape, in particular with a single opening (namely the cartridge opening) at an end face. Preferably, the collection cartridges are commercially available Evotips® (see, e.g., [5]) or cartridges with a shape matched to Evotips®. Evotips® are disposable trap columns that speed up sample loading and significantly reduce carry-over, resulting in simplified workflows as integrating elution with liquid chromatography removes several sample handling steps as well as reduces injection cycle overheads.

Preferably, the collection cartridges are integral components. In particular, the cartridge coupling section preferably is an integral part of the remaining collection cartridge. Alternatively, the collection cartridges are made of multiple parts, e.g. a cartridge body and the cartridge coupling section fixed to the cartridge body.

Preferably, the collection cartridges (also called stage tips) are tip shaped containers, particularly preferred made of an inert polymer material, like e.g. a C18 material, which typically has polymeric non-polar endcapping and a high carbon content, as it is known e.g. for obtaining advantages for desalting/cleaning a protein digest sample before injection into a chromatographic separation column.

According to the invention, each vessel coupling section is matched to each cartridge coupling section with form-fitting so that they are adapted for (in particular liquid tight) coupling the reaction substrate device and the plurality of collection cartridges, thereby providing direct liquid communication of the vessels and the collection cartridges via the openings thereof. Preferably, each vessel coupling section and each cartridge coupling section are adapted for a direct mutual coupling. Preferably, a contact area of the vessel coupling section and the cartridge coupling section in contact with each other has a round, in particular circular or elliptic cross-section shape.

In particular, the sample substrate enables 1 -to-1 coupling of the vessels and the collection cartridges. In other words, the sample substrate is adapted for enabling (individual) coupling of (exactly) one of the vessels and (exactly) one of the collection cartridges, particularly via the respective vessel coupling section and cartridge coupling section. The coupling provides direct liquid communication between (exactly) one of the vessels and (exactly) one of the collection cartridges. One or multiple sample(s) prepared in one of the vessels can therefore only be transferred in only one of the collection cartridges.

The term “coupling section” generally refers to a topographic structural feature (or element) providing an exposed engagement shape, in particular with an inherent liquid tightness, when coupled with another coupling section with complementary shape. Each coupling section of the reaction substrate device, in particular an open end portion of one the vessels providing the vessel opening, matches with a coupling section, in particular an open end portion of one of the collection cartridges providing the cartridge opening.

Advantageously, the coupling sections additionally provide a mechanical connection of the vessels and the collections cartridges, even during sample transfer, e. g. by centrifugation. Optionally, the mechanical connection of the vessels and the collections cartridges can be further supported by the design of a centrifugation device, holding the vessels and the collections cartridges together, and/or by fixing elements providing an additional clamping and/or screwing connection between the vessels and the collections cartridges in the coupled state thereof.

According to a second general aspect of the invention, the above objective is solved by a liquid sample analyzing apparatus, being adapted for preparing samples for a LC-MS sample analysis (e.g., a proteomics mass spectrometry analysis) and executing the LC-MS sample analysis, comprising a sample substrate according to the first general aspect of the invention or an embodiment thereof, and an LC-MS apparatus.

According to a third general aspect of the invention, the above objective is solved by a method of executing an LC-MS sample analysis (e.g., a proteomics mass spectrometry analysis), wherein a sample substrate according to the first general aspect of the invention or an embodiment thereof and an LC-MS apparatus are employed. The method comprises collecting samples to be analyzed in the vessels of the sample substrate, subjecting the (collected) samples to a decomposition reaction in the vessels, and coupling each of the collection cartridges with one of the vessels (preferably after subjecting the samples). The method further comprises transferring (e.g., pooling) the decomposed samples from each of the vessels to the coupled collection cartridges, decoupling the collection cartridges from the vessels and then coupling the collection cartridges with the LC-MS apparatus, and conducting the LC-MS sample analysis with the LC-MS apparatus.

While performing the method, the sample substrate, particularly the reaction substrate device, may be arranged in two different positions (orientations relative to gravity). In particular, when collecting the samples, subjecting the samples to decomposition reaction and coupling the collection cartridges to the vessels, the reaction substrate device is arranged in a first position, wherein the vessels are arranged on a top side of the reaction substrate device and/or the vessel openings are oriented upwards, i.e. facing in a direction opposite to direction of gravity. After and optionally already during transferring the decomposed samples, the sample substrate is arranged in a second position, wherein the vessels are arranged on a lower side of the reaction substrate device and/or the vessel openings are oriented downwards, i.e. facing in the direction of gravity. Preferably, the sample substrate is moved from the first to the second position by turning the sample substrate upside down. In the second position, the decomposed samples are enabled to flow from the vessels to the (coupled) collection cartridges by the effect of gravity. Preferably, this sample transfer is further supported by centrifugation.

Preferably, the samples to be prepared and analyzed using the sample substrate comprise biological material, in particular biological cells, cell groups and/or cell components. For instance, the biological material can be one single cell, multiple cells or at least one piece of biological material originating from tissue slices (such as fresh frozen tissue or paraffin embedded FTPE tissue slices).

Additionally, the decomposition reaction preferably comprises cell lysis and/or protein digestion. For instance, reagents are added that will allow cell lysis and protein digestion into peptide fragments.

The invention has the following advantages. The sample substrate can be used to perform all the steps of a sample preparation protocol before the subsequent analysis can be undertaken by LC-MS methods (mass spectrometry). In particular, the sample substrate allows a direct and preferably automatic transfer (e.g., pooling) of the samples prepared in the vessels to the collection cartridges, such as Evotips®, thereby excluding from the workflow the use of additional auxiliary transfer pipettes and/or pipetting steps to undertake the transfer of the prepared sample before their introduction to the analysis device, in particular the LC-MS apparatus. Eliminating pipetting steps will result in reduced peptide losses that normally occurs on the walls of the transfer pipettes. In particular concerning single or low amount cell (e.g., protein) samples prepared for single cell proteomic analyses, wherein sample sizes are generally already low (usually<ng), employing the sample substrate according to the present invention offers an increased number of proteins detected from each sample.

As further advantages, the provision of the direct transfer of the samples prepared in the vessels to the collection cartridges results in a much more accelerated transfer compared to the conventional, manual techniques. Additionally, the sample volumes used for sample preparation (sample reactions) in the vessels (“reaction volume”) can be reduced depending on the application conditions, down to samples with a volume below 1 μl, in particular below 100 nl, down to, e.g., 1 nl or even below. After preparation, the sample volumes can be increased by a step of dilution before a transfer via centrifugation to be e.g. 1 μl to 10 μl (“transferred volume”). The size of the vessels can be reduced, thus facilitating the handling of the sample substrate and facilitating measures against evaporation. By the assignment of the vessels to the collection cartridges, the multiplexing of the sample preparation is supported. As a further advantage, the sample substrate can be easily manufactured, e.g., from a low-cost plastics material, and/or can be provided and used as a single-use or reusable consumable.

Further advantageously, the application of the invention is possible for preparing the plurality of liquid samples for various types of sample analyses. For example, multiple single cell, multiple cells and/or cell components can be arranged at each of the reactions vessels. The samples can be prepared, e.g., for a subsequent mass spectrometry, optionally combined with a liquid chromatographic separation of sample components, and/or for another analysis, e.g., a genomic analysis, including a sequencing measurement.

Additionally, the sample substrate according to present invention can be incorporated in various sample collection apparatuses to reduce the number of manual operation required and improve the quality/sensitivity of, e.g., proteomics mass spectrometry results. For instance, the sample substrate may be used in association with the sample collection apparatus (also called proteo-CHIP) disclosed in [7].

According to optional variants of the invention, the vessels may be arranged in a matrix and/or array, wherein the vessels are spaced apart from each other. The number of vessels and the type of arrangement can be selected in dependency on the degree of parallelism of sample handling to be obtained, e.g., in dependency on the number of different labeling molecules to be applied. Additionally, the shape of the reactions vessel can be selected in dependency on, e.g., application conditions of the sample preparing apparatus and the applied sample liquid handling technique. According to a preferred embodiment of the invention, each cartridge coupling section is matched to a shape of a sample input section of an LC-MS apparatus. Advantageously, the collection cartridges can be removed from the reaction substrate device after the samples have been transferred from the vessels to the collection cartridges, and directly placed into the LC-MS apparatus without the necessity of further transferring the samples into other vessels to execute the LC-MS analysis. For instance, in case that Evotips® are used as collection cartridges, the Evotips® enable direct interfacing with an Evosep® Liquid Chromatography system for mass spectroscopy analysis.

According to a further preferred embodiment of the invention, one of the vessel coupling section and the cartridge coupling section is formed by a protruding rim at the vessel opening of the vessel or the cartridge opening of the collection cartridge, resp., and the other one of the vessel coupling section and the cartridge coupling section is provided by an inner wall section at the vessel opening or the cartridge opening, resp. When coupled, the protruding rim and the inner wall section are in direct contact, e.g., wherein the inner wall section is surrounding the protruding rim. The coupling combination of a rim and an inner wall has particular advantages in terms of integration into the materials of the reaction substrate device, particularly the vessels, and the collection cartridges and a reliable liquid tight connection in particular between plastics materials. Preferably, the rim has a shape of a truncated cone.

Particularly preferred, the protruding rim has a cone shape. Advantageously, the cone-shaped further facilitates a simplified coupling of the vessel coupling section and the cartridge coupling section.

According to a preferred variant of the invention (in the following: first embodiment or single plate embodiment of the invention), the reaction substrate device comprises a single plate including the plurality of vessels. The vessels may be formed as wells within the single plate. Accordingly, the reaction substrate device may be a well plate, wherein each well is provided with one of the vessel coupling sections. This single plate embodiment is particularly preferred for the preparation of samples comprising label free reactions.

According to an alternative preferred variant of the invention (in the following: second embodiment or two plate embodiment of the invention), the reaction substrate device comprises a stack of two plates, including a carrier plate and a funnel plate. The carrier plate includes multiple arrays of at least two of the accommodating spaces of the vessels, wherein each array has a carrier plate coupling section with a vessel section opening. The funnel plate includes a plurality of funnel shaped open passages, wherein each funnel shaped open passage comprises a first end having a funnel coupling section with a funnel coupling opening, and a second end providing one of the vessel coupling sections. The carrier plate coupling sections and the funnel coupling sections are matched to each other with form-fitting so that they are adapted for (in particular liquid tight) coupling the carrier plate and the funnel plate, thereby forming the plurality of vessels each comprised of one of the arrays of the at least two of the accommodating spaces and one of the funnel shaped open passages coupled to each other and being in direct liquid communication via the vessel section opening and the funnel coupling opening thereof. With the second embodiment, each vessel is provided by one of the arrays of the accommodating spaces in combination with one of the funnel shaped open passages.

The two plate embodiment comprising the stack of the carrier plate and the funnel plate is particularly preferred for preparation of samples comprising multiplexed reactions. For instance, the carrier plate may correspond to the carrier plate device disclosed in [6], which is herewith incorporated by reference, in particular with regard to the shape, size and method of using the carrier plate device.

A particular advantage of the second embodiment is given by the double function of the reaction substrate in terms of accommodating samples and pooling samples. With the funnel plate, multiple samples separately prepared in different accommodating spaces of an array may be pooled into a common collection cartridge.

According to another preferred embodiment of the invention, the sample substrate may include at least one of the following features. The vessels have a volume in a range from 100 nl to 10 μl. The collection cartridges have a volume in a range from 10 μl to 1 ml. An inner diameter of one of the vessel coupling section and the cartridge coupling section is equal to an outer diameter of the other one of the vessel coupling section and the cartridge coupling section. One of the vessel coupling section and the cartridge coupling section has an inner diameter in a range from 1 mm to 10 mm and the other one of the vessel coupling section and the cartridge coupling section has an outer diameter in a range from 1 mm to 10 mm. The sample substrate and/or the whole reaction substrate device is made of glass, plastic, silicon, polytetrafluoroethylene, polypropylene and/or polycarbonate. All components of the reaction substrate device may be made from the same material, or different components may be made of different materials.

Preferably, in case of employing protruding vessel coupling sections, a longitudinal length (height) of the vessel coupling sections is selected in a range from 1 mm to 10 mm, in particular from 2 mm to 10 mm. Advantageously, in particular the stable connection of the coupling sections during centrifugation is improved with these parameters.

The preferred embodiments, variants and features of the invention described above are combinable with one another as desired. Features disclosed in the context of the sample substrate and the embodiments thereof also represent preferred features of the inventive method and embodiments thereof and vice versa. The aforementioned aspects and inventive and preferred features, in particular with regard to the execution of the method, therefore also apply for the sample substrate.

### BRIEF DESCRIPTION OF THE DRAWINGS

Further advantages and details of the invention are described in the following with reference to the attached drawings, which schematically show in:

FIGS. 1 to 3: a single plate of a reaction substrate device according to the first embodiment of the invention, shown from different perspectives;

FIG. 4: a sample substrate according to the first embodiment;

FIG. 5: a carrier plate of a reaction substrate device according to the second embodiment of the invention;

FIGS. 6 to 9: a funnel plate of the reaction substrate device according to the second embodiment, shown from different perspectives;

FIG. 10: a sample substrate according to the second embodiment; and

FIGS. 11 to 12: an alternative single plate according to the first embodiment.

### DESCRIPTION OF PREFERRED EMBODIMENTS

Features of preferred embodiments of the invention are described in the following with exemplary reference to sample preparation for the LC-MS/MS analysis. It is emphasized, that the application of the invention is not restricted to these examples, but correspondingly possible with other analyses, e.g., by using other samples and reagents, in particular in the field on proteomics sample preparation. Furthermore, while the sample substrate is schematically shown, details, like, e. g., the number, shape and size of the vessels and/or accommodating spaces and/or the number, shape and size of the collection cartridges can be modified in dependency on the particular applications conditions. Details of the sample processing for proteomics investigations are not described as far as they are known per se from conventional techniques, like e. g. [1] to [4].

Exemplary reference is made to embodiments with a protruding vessel coupling section accommodated by the cartridge coupling section, i.e. wherein the vessel coupling section is introduced into the cartridge coupling section. The invention can be implemented in equal manner with alter-native shapes, in particular with with a protruding cartridge coupling section accommodated by the vessel coupling section, i.e. wherein the cartridge coupling section is introduced into the vessel coupling section.

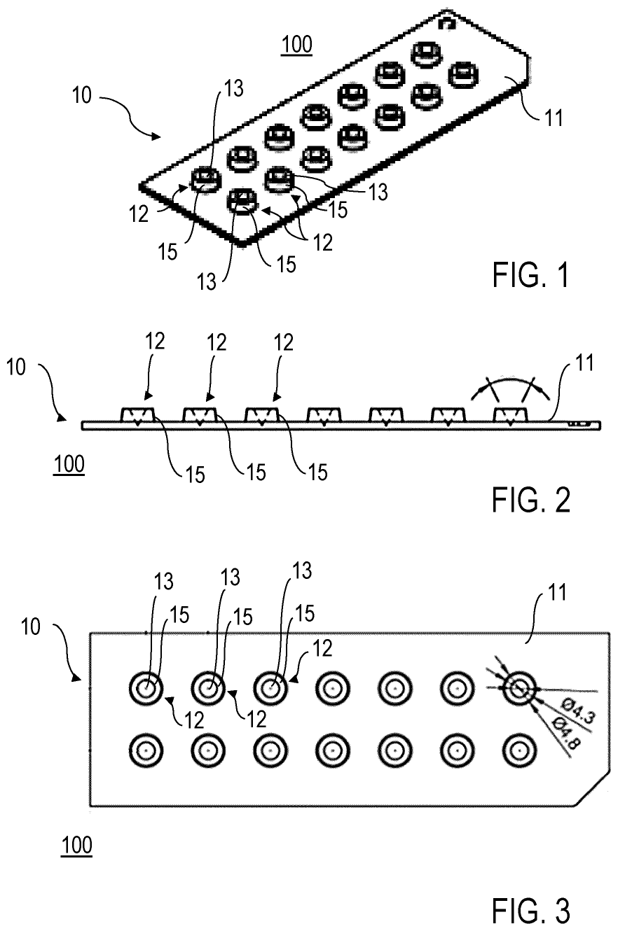

FIGS. 1, 2 and 3 show the first embodiment (single plate embodiment) with a single plate 10 of a reaction substrate device of a sample substrate 100. Specifically, the single plate 10 is shown from different perspectives, namely a perspective view (FIG. 1), a side view (FIG. 2) and a top view (FIG. 3).

The reaction substrate device comprises the single plate 10 including a plurality of, preferably conical, vessels 12, such as wells. Each vessel 12 has one single accommodating space being configured for accommodating a liquid sample and a vessel coupling section 15 with a vessel opening 13. Alternatively, each vessel 12 could be subdivided into multiple accommodating spaces. The vessels 12 are spaced apart from each other. Preferably, each vessel opening 13 is the only opening of the respective vessel 12. The vessel coupling sections 15 are formed by protruding rims of the vessels 12.

In the illustrated example, an array of fourteen vessels 12 are provided, arranged in two rows of seven vessels 12. As a practical example, each vessel 12 has an inner diameter of 4.3 mm at the vessel opening 13 and an outer diameter of 4.8 mm, a depth of 1 mm and a distance between centres of vessels 12 of 9 mm. The vessel coupling sections 15 have a height of e.g. 2 mm.

Additionally, each vessel 12 has an inner shape narrowing from the vessel opening 13 towards the vessel bottom. As a practical example, each vessel 12 has an inner diameter at the vessel bottom of 2.5 mm and/or an opening angle of the inner shape towards the vessel opening 13 of 52° (see FIG. 2). Alternatively, cylindrical inner shapes could be provided.

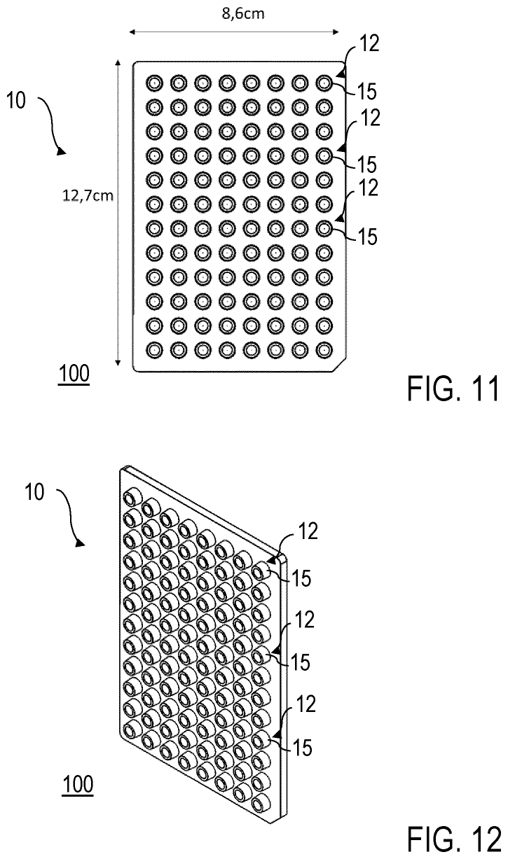

The carrier plate device 10 further comprises a main plate section 11 which preferably has a plane shape. The main plate section 11 provides a substrate defining the outer lateral size of the single plate 10, wherein various geometries may be used in dependency on the application conditions. The outer lateral size may be selected to be equal to a size of a microscope slide, e.g., about 75 mm*25 mm with a thickness of about 1 mm. Alternatively, another, e.g., larger outer lateral size can be used, like 8.6 cm*12.7 cm with an arrangement of 8*12 vessels, as shown in FIGS. 11 and 12, being matched to a specific substrate size processed in a sample collection (and processing) machine. With the embodiments of FIGS. 1 and 12, the height of the vessel coupling sections 15 is e.g. 2 mm.

The carrier plate device 10 may comprise a standard microwell or nanowell plate, wherein each well is provided with a vessel coupling section as described.

The vessels 12 are arranged on the main plate section 11. Preferably, all vessels 12 are arranged on one side of the main plate section 11, wherein an opposite side of the main plate section 11 may be used for placing the single plate 10, e.g., on a table when collecting samples to be analyzed in the vessels 12.

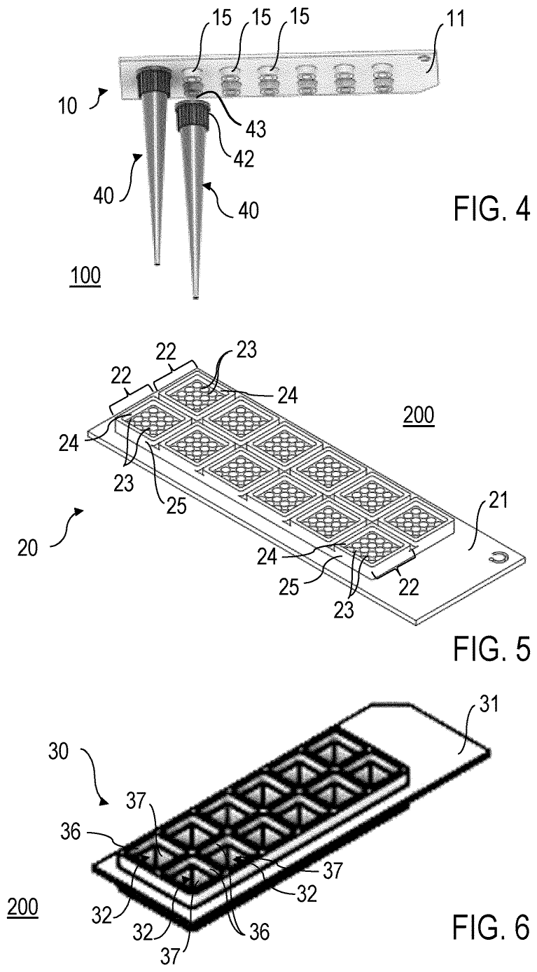

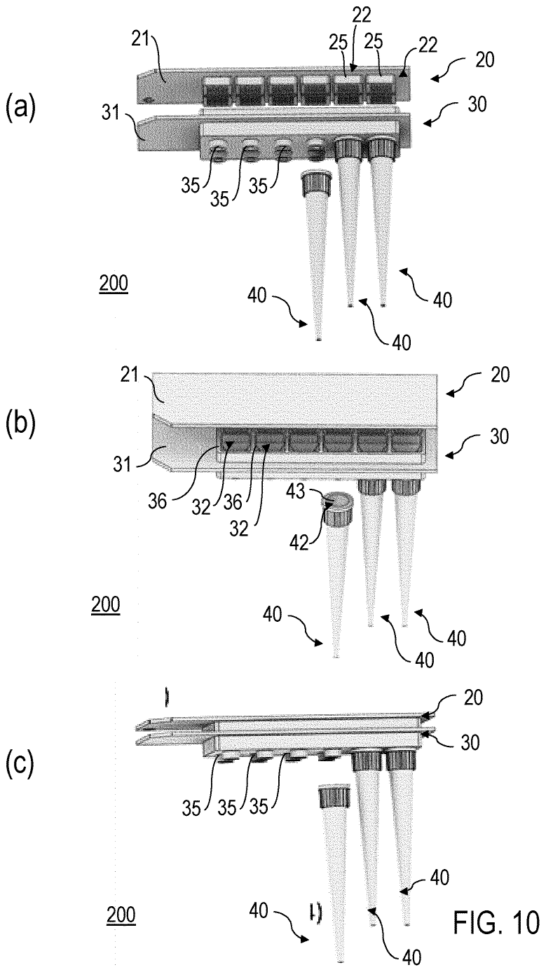

FIG. 4 shows the sample substrate 100 according to the first embodiment, wherein the sample substrate 100 further comprises a plurality of collection cartridges 40, such as Evotips®, each having a cartridge coupling section 42 with a cartridge opening 43 (see also FIG. 10(b) with respect to the second embodiment) and being configured for accommodating the liquid sample from one of the vessels 12. Preferably, the cartridge opening 43 is the only opening of the respective collection cartridge 40. Each of the collection cartridges 40 preferably has a shape of a pipette tip, a conus, and/or a column.

The sample substrate 100 is in particular characterized in that each vessel coupling section 15 is matched to each cartridge coupling section 42 with form-fitting. Thus, one of the collection cartridges 40 and one of the vessels 12 can be directly coupled with each other by form-fit via the respective vessel coupling section 15 and respective cartridge coupling section 42. Consequentially, by forming such as a form-fit coupling, a direct liquid communication via the vessel opening 13 of the vessel coupling section 15 and the cartridge opening 43 of the cartridge coupling section 42 is provided. Preferably, each vessel coupling section 15 and each cartridge coupling section 42 are adapted for a direct mutual coupling.

The sample substrate 100 is illustrated in a simplified manner in FIG. 4, comprising only two collection cartridges 40, one being coupled to the vessel 12 and the other one being arranged adjacent to the single plate 10 to illustrate the detachable coupling of a collection cartridge 40 and a vessel 12 provided by the sample substrate 100 according to the present invention.

In the illustrated example, each of the vessel coupling sections 15 is formed by the protruding rim at the vessel opening 13 of the vessel coupling section 15, specifically an outer wall section of the sidewall forming the respective vessel 12. The protruding rim preferably has a cone shape. The side walls therefore fulfil a double function in terms of forming the vessels 12 on the main plate section 11 and coupling with the collection cartridges 40.

Correspondingly, each of the cartridge coupling sections 42 is provided by an inner wall section at the cartridge opening 43 of the cartridge coupling section 42, specifically an inner wall section of the sidewall forming the collection cartridge 40. The side walls of the collection cartridges 40 therefore also fulfil a double function in terms of forming the collection cartridges 40 and coupling with the vessels 12.

According to the illustrated example, a collection cartridge 40 can be coupled to a vessel 12 in a simple manner by putting the cartridge coupling section 42 over the vessel coupling section 15. This can be done manually or with a machine, in particular in an automated process.

Alternatively, each of the cartridge coupling sections 42 may be formed by a protruding rim at the cartridge opening 43 of the cartridge coupling section 42, such as an outer wall section of the sidewall forming the collection cartridge 40. Correspondingly, each of the vessel coupling sections 15 may be provided by an inner wall section at the vessel opening 13 of the vessel coupling section 15, such as an inner wall section of the sidewall forming the vessel 12.

The sample substrate 100 may be employed for preparing samples for an LC-MS analysis and/or executing an LC-MS sample analysis (e.g., a proteomics mass spectrometry analysis), wherein the sample substrate 100 in particular enables single or low amount cell (e.g., protein) samples preparation for single cell proteomic analyses, wherein sample sizes are generally already low (usually<ng). All steps of a sample preparation protocol before the subsequent sample analysis can be performed in the sample substrate 100.

In a first step, samples to be analyzed are collected in the vessels 12. In particular, the reaction substrate device 100, namely the single plate 10, is provided in a first position without the plurality of collection cartridges 40. Preferably, the single plate 10 may be placed on a, e.g., table, wherein the vessels 12 are arranged on a top side of the single plate 10 and/or the vessel openings 13 are oriented upwards. That way, the samples can be supplied to the vessels 12 via the vessel openings 13.

The samples may comprise biological material, such as biological cells, cell groups and/or cell components. Preferably, the biological material comprises one single cell, multiple cells or at least one piece of biological material originating from tissue slices (such as fresh frozen tissue or paraffin embedded tissue slices).

In a second step, the samples are subjected to decomposition reaction in the vessels 12, wherein the decomposition reaction preferably comprises cell lysis and/or protein digestion. For instance, reagents are supplied to the vessels 12 that will allow cell lysis and protein digestion of the samples into peptide fragments. As an example, the liquid samples and the reagents may be supplied using a droplet handling and processing machine, such as an automated pipetting robot, with, e.g., a piezoelectric droplet dispenser. Alternatively, the liquid samples and the reagents are supplied by hand pipetting.

The first two steps may be performed at different temperatures, e.g., from 5 to 100 °C.

In a third step, each of the collection cartridges 40 are coupled with one of the vessels 12, while the single plate 10 is still in the first position. Thus, the cartridge openings 43 of the collection cartridges 40 are oriented downwards when the respective cartridge coupling sections 42 are coupled by form-fit to the vessel coupling sections 15. Accordingly, the collection cartridges 40 are arranged at the top side of the single plate 10.

In a fourth step, the decomposed samples are transferred, e.g., pooled, from each of the vessels 12 to the coupled collection cartridges 40. In particular, after the collection cartridges 40 and the vessels 12 are coupled with each other, the whole sample substrate 100 is turned upside down. In other words, the sample substrate 100 is moved in the second position, wherein the vessels 12 and the collection cartridges 40 are arranged at a bottom side of the single plate 10. That way, the decomposed samples can flow from each of the vessels 12 to the coupled collection cartridges 40 by the effect of gravity.

In practice, the sample transfer (e.g., pooling) is further facilitated by subjecting the sample substrate 100 to a centrifugation, e. g. in a laboratory centrifuge, so that the decomposed samples from all vessels 12 flow to the bottom of the respectively coupled collection cartridges 40.

In a fifth step, the collection cartridges 40 filled with the decomposed samples are decoupled from reaction substrate device, namely the single plate 10, and coupled with a LC-MS apparatus. The LC-MS apparatus has an input section for sample input. As, according to a preferred embodiment of the invention, cartridge coupling sections are matched to the shape of the sample input section of the LC-MS apparatus, the collection cartridges 40 can be directly (and without an additional pipetting step) coupled with the LC-MS apparatus. Preferably, the LC-MS/MS apparatus is a tandem mass spectrometer, including a liquid chromatography unit and a mass spectrometer. In case that Evotips® are used as collection cartridges 40, the LC-MS apparatus may be an Evosep® Liquid Chromatography system for mass spectroscopy analysis.

Finally, in a sixth step, a LC-MS sample analysis is conducted with the LC-MS apparatus. For instance, peptide fragments situated in the decomposed samples are subjected to an ionisation, and a first spectrometer stage (survey scan) separates the ions by their mass-to-charge ratio (m/z). Ions of particular m/z ratios are selected. These ions are split into smaller fragment ions, and these fragment ions are introduced into the second spectrometer stage (identification scan) for separation by their m/z-ratio and detection. Alternatively, the mass spectrometer can rely on time of flight (TOF) technology. Chromatographic separation may occur in the collection cartridges 40 during the LC-MS sample analysis.

According to the second, two plate embodiment of the invention, the reaction substrate device of the sample substrate 200 comprises a stack of two plates, namely a carrier plate 20 and a funnel plate 30.

FIG. 5 shows such a carrier plate 20, which includes a plurality of, preferably rectangular, arrays 22, each having at least two accommodating spaces 23 for accommodating liquid samples. In the illustrated example, each of the plurality of array 22 is an array of nine accommodating spaces 23 each being configured for accommodating a liquid sample.

Additionally, each array 22 has a carrier plate coupling section 25 with a vessel section opening 24. The arrays 22 are spaced apart from each other or adjacent to each other. Preferably, the, in particular square or rectangular, vessel section opening 24 is the only opening of the respective array 22. In the illustrated example, an arrangement of twelve arrays 22 is provided, comprising two rows of six arrays 22.

The carrier plate 20 further comprises a main carrier plate section 21 which preferably has a plane shape. The main carrier plate section 21 provides a substrate defining the outer lateral size of the reaction substrate device. Properties, such as measures, of the main carrier plate section 21 may be the same or at least similar to properties of the main plate section 11 according to the first embodiment of the invention.

The arrays 22 are arranged on the main carrier plate section 21. Preferably, all arrays 22 are arranged on one side of the main carrier plate section 21, wherein an opposite side of the main carrier plate section 21 may be used for placing the reaction substrate device, e.g., on a table when collecting samples to be analyzed in the arrays 22.

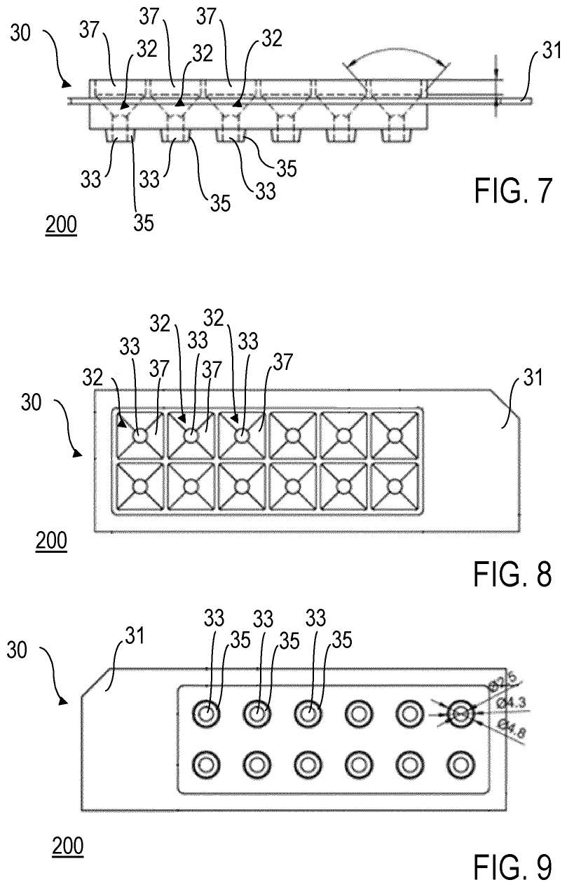

FIGS. 6, 7, 8 and 9 show the funnel plate 30 according to the second embodiment. The funnel plate 30 is shown from different perspectives, namely a perspective view (FIG. 6), a side view (FIG. 7), a top view (FIG. 8) and the bottom view (FIG. 9).

The funnel plate 30 includes a plurality of funnel shaped open passages 32, wherein each funnel shaped open passage 32 comprises a first end having a funnel coupling section 36 with a funnel coupling opening 37, and a second end providing one of the vessel coupling sections 35. Each of the vessel coupling sections 35 provides a vessel opening 33. Preferably, the vessel coupling sections 15, 35 of the first and second embodiment, and consequentially also the vessel openings 13, 33 of the first and second embodiments, are equal. In the illustrated embodiment, an array of funnel shaped open passages 32 are provided, arranged into rows of six funnel shaped open passage 32, corresponding to the arrangement of the carrier plate vessels 22 of the carrier plate 20 shown in FIG. 5.

As a practical example, each vessel opening 33 has a square cross-section of 8.2 mm*8.2 mm and a distance between centres of funnel shaped open passages 32 is 9 mm. Additionally, each funnel shaped open passage 32 has a total depth of about 7 to 8 mm and a narrowing inner shape with an opening angle of the inner shape towards the vessel opening 33 of 82°. The cross-section of each funnel shaped open passage 32 may be constant at the vessel opening 33 up to a depth of about 3 mm, forming the funnel coupling section 36. The overall arrangement of the funnel shaped open passages 32 with an outer lateral size of about 55 mm*15 mm and a uniform thickness (excluding the vessel coupling sections 35) of about 7 to 8 mm.

Furthermore, in the illustrated example, the vessel coupling sections 35 have identical or at least similar properties, in particular measures, like the vessels 12 (and therefore the vessel coupling sections 15) of the first embodiment. The vessel coupling sections 35 may have a constant inner shape with a cross-section of 2.5 mm.

Accordingly, each of the funnel shaped open passages 32 is adapted for fluidically connecting a funnel coupling opening 37 of a funnel coupling section 36 with a vessel opening 33 of the respective vessel coupling section 35.

The funnel plate 30 further comprises a main funnel plate section 31 which preferably has a plane shape. The funnel shaped open passages 32 are arranged within the main funnel plate section 31 and/or pass through the main funnel plate section 31, preferably vertically. Thus, the first ends of the funnel shaped open passages 32 are arranged on one side of the main funnel plate section 31 and the second ends of the funnel shaped open passages 32, i.e., the vessel coupling sections 35, are arranged on an opposite side of the main funnel plate section 31. Preferably, properties, such as measures, of the main funnel plate section 31 are the same or at least similar to properties of the main carrier plate section 21. In the illustrated example, the main funnel plate section 31 has the same outer lateral size as the carrier plate section 21 of about 75 mm*25 mm with a thickness of about 1 mm.

FIG. 10 shows different views of the sample substrate 200 according to the second embodiment, which further comprises the plurality of collection cartridges 40. The collection cartridges 40 are preferably identical for both of the first and second embodiments.

Similar to FIG. 4, the sample substrate 200 is illustrated in a simplified manner in FIG. 10, comprising only three collection cartridges 40, two being individually coupled to one of vessels, respectively, and the third one being arranged adjacent to the reaction substrate device 200 to illustrate the detachable coupling of a collection cartridge 40 and a vessel provided by the sample substrate 200 according to the present invention.

As illustrated by the views (a), (b) and (c) of FIG. 10, the carrier plate 20 and the funnel plate 30 can be detachably coupled with each other. In particular, each carrier plate coupling section 25 and each funnel coupling section 36 are matched to each other with form-fitting so that they are adapted for coupling the carrier plate 20 and the funnel plate 30.

Due to this form-fit coupling, the vessels are formed, each composed of one of the arrays 22 of accommodating spaces and one of the funnel shaped open passages 32 coupled to each other, wherein a direct liquid communication between the respective array 22 and funnel shaped open passage 32 is provided via the vessel section opening 24 and the funnel coupling opening 37 thereof.

Accordingly, a direct communication between the respective carrier plate vessel 22, such as an area of accommodating spaces 23, and a collection cartridge 40 is provided via the funnel shaped open passage 32.

The sample substrate 200 may be employed for preparing samples for an LC-MS analysis and/or executing an LC-MS sample analysis, similarly to the sample substrate 100, as previously described. In particular, the sample substrate 200 also enables single or low amount cell (e.g., protein) samples preparation for single cell proteomic analyses, wherein sample sizes are generally already low (usually <ng). All steps of a sample preparation protocol before the subsequent sample analysis can be performed in the sample substrate 200.

In a first step and a second step, samples to be analyzed are collected in the vessels, specifically in the accommodating spaces 23 of the arrays 22, and the samples are subjected to decomposition reaction in the accommodating spaces 23. In particular, similar to the single plate 10 according to the first embodiment, the carrier plate 20 is provided in a first position without the plurality of collection cartridges 40. Preferably, the carrier plate 20 may be placed on a, e.g., table, wherein the arrays 22 are arranged on a top side of the carrier plate 20 and/or the vessel section openings 24 are oriented upwards. That way, the samples and, e.g., reagents, can be supplied to the arrays 22 via the vessel section openings 24.

The first two steps may be performed with or without the funnel plate 30 being coupled to the carrier plate 20. In other words, the funnel plate 30 may be coupled to the carrier plate 20 after the first two steps have been performed.

In a third step, each of the collection cartridges 40 are coupled with one of the vessels, while the carrier plate 20 is still in the first position. There are two possibilities to perform said third step. According to one possibility, the funnel plate 30 is coupled to the carrier plate 20 which is still in the first position. Accordingly, the funnel plate 30 and therefore also vessel coupling sections 35 are arranged at the top side of the reaction substrate device. Thus, the cartridge openings 43 of the collection cartridges 40 are oriented downwards when the respective cartridge coupling sections 42 are coupled by form-fit to the vessel coupling sections 35. Alternatively, according to another possibility, the funnel plate 30 and the carrier plate 20 are still uncoupled, wherein the collection cartridges 40 are first coupled by form-fit to the vessel coupling sections 35, and then the whole arrangement of the funnel plate 30 and the collection cartridges 40 are placed on top of the carrier plate 20 so that the funnel plate 30 can be coupled to the carrier plate 20.

In a fourth step, the decomposed samples are transferred from each of the vessels to the coupled collection cartridges 40. In particular, after the collection cartridges 40 and the vessels are coupled with each other, the whole sample substrate 200 is turned upside down, moving the sample substrate 200 in the second position. The decomposed samples can flow from each of the vessels to the coupled collection cartridges 40 by the effect of gravity and preferably additionally by centrifugation.

Possible fifth and sixth steps may correspond to the ones as previously described with respect to the first embodiment.

The features of the invention disclosed in the above description, the drawings and the claims can be of significance both individually as well as in combination or sub-combination for the realization of the invention in its various embodiments. The invention is not restricted to the preferred embodiments described above. Rather a plurality of variants and derivatives is possible which also use the inventive concept and therefore fall within the scope of protection. In addition, the invention also claims protection for the subject and features of the subclaims independently of the features and claims to which they refer.

1. A sample substrate, being configured for preparing samples for an LC-MS analysis, comprising
a reaction substrate device having a plurality of vessels, each having at least one accommodating space being configured for accommodating a liquid sample and a vessel coupling section with a vessel opening, and
a plurality of collection cartridges, each having a cartridge coupling section with a cartridge opening and being configured for accommodating the liquid sample from one of the vessels, wherein
each vessel coupling section is matched to each cartridge coupling section with form-fitting so that they are configured for coupling the reaction substrate device and the plurality of collection cartridges, thereby providing direct liquid communication of the vessels and the collection cartridges via the vessel opening and the cartridge openings.

2. The sample substrate according to claim 1, wherein
each cartridge coupling section is matched to a shape of a sample input section of the LC-MS apparatus.

3. The sample substrate according to claim 1, wherein
each of the collection cartridges has a shape of a pipette tip or conus.

4. The sample substrate according to claim 1, wherein
one of the vessel coupling section and the cartridge coupling section is formed by a protruding rim at the vessel opening or the cartridge opening, and the other one of the vessel coupling section and the cartridge coupling section is provided by an inner wall section at the vessel opening or the cartridge opening.

5. The sample substrate according to claim 4, wherein
the protruding rim has a cone shape.

6. The sample substrate according to claim 1, wherein
each vessel coupling section and each cartridge coupling section are configured for a direct mutual coupling.

7. The sample substrate according to claim 1, wherein
the reaction substrate device comprises a single plate including the plurality of vessels.

8. The sample substrate according to claim 1, wherein
the reaction substrate device comprises a stack of two plates, including a carrier plate and a funnel plate, wherein
the carrier plate includes multiple arrays of at least two of the accommodating spaces of the vessels, wherein each array has a carrier plate coupling section with a vessel section opening, and
the funnel plate includes a plurality of funnel shaped open passages, wherein each funnel shaped open passage comprises a first end having a funnel coupling section with a funnel coupling opening, and a second end providing one of the vessel coupling sections, wherein
the carrier plate coupling sections and the funnel coupling sections are matched to each other with form-fitting so that they are configured for coupling the carrier plate and the funnel plate, thereby forming the plurality of vessels each comprised of one of the arrays of the at least two of the accommodating spaces and one of the funnel shaped open passages coupled to each other and being in direct liquid communication via the vessel section opening and the funnel coupling opening thereof.

9. The sample substrate according to claim 1, wherein
the vessels have a volume in a range from 100 nl to 10 μl.

10. The sample substrate according to claim 1, wherein
the collection cartridges have a volume in a range from 10 μl to 1 ml.

11. The sample substrate according to claim 1, wherein
an inner diameter of one of the vessel coupling section and the cartridge coupling section is equal to an outer diameter of the other one of the vessel coupling section and the cartridge coupling section.

12. The sample substrate according to claim 1, wherein
one of the vessel coupling section and the cartridge coupling section has an inner diameter in a range from 1 mm to 10 mm and the other one of the vessel coupling section and the cartridge coupling section has an outer diameter in a range from 1 mm to 10 mm.

13. The sample substrate according to claim 1, wherein
the sample substrate is made of at least one of glass, plastic, silicon, polytetrafluoroethylene, polypropylene and polycarbonate.

14. A liquid sample analyzing apparatus, being configured for preparing samples for a LC-MS sample analysis and executing the LC-MS sample analysis, comprising
a sample substrate according to claim 1, and
an LC-MS apparatus.

15. A method of executing an LC-MS sample analysis, wherein a sample substrate according to claim 1 and an LC-MS apparatus are employed, comprising
collecting samples to be analyzed in the vessels of the sample substrate,
subjecting the samples to a decomposition reaction in the vessels,
coupling each of the collection cartridges with one of the vessels,
transferring the decomposed samples from each of the vessels to the coupled collection cartridges,
coupling the collection cartridges with the LC-MS apparatus, and
conducting the LC-MS sample analysis with the LC-MS apparatus.

16. The method according to claim 15, wherein
the samples comprise biological material, and
the decomposition reaction comprises cell lysis and protein digestion.

17. The method according to claim 16, wherein
the biological material comprises at least one of biological cells, cell groups and cell components.
